(19) United States
(12) Patent Application Publication
(10) Pub. No.: US 2025/0189015 A1
(43) Pub. Date: Jun. 12, 2025

(54) PORTABLE MACHINE TOOL KITS WITH ADAPTIVE GEARBOXES

(71) Applicant: Climax Portable Machine Tools, Inc., Newberg, OR (US)

(72) Inventors: Scott J. THIEL, Sherwood, OR (US); Raymond J. JENTGES, Newberg, OR (US)

(21) Appl. No.: 18/965,920

(22) Filed: Dec. 2, 2024

Related U.S. Application Data
(60) Provisional application No. 63/606,926, filed on Dec. 6, 2023.

(51) Int. Cl. F16H 3/30; B23B 45/00; F16H 3/00; F16H 57/02; F16H 59/04; F16H 59/08

(52) U.S. Cl. CPC F16H 3/30; B23B 45/008; F16H 3/006; F16H 59/042; F16H 59/08; F16H 2057/02034; F16H 2057/02073; F16H 2059/081

(57) ABSTRACT

Portable machine tool kits (10) for assembling portable machine tools (12) comprise a gearbox (14) and a plurality of input gears (26. The gearbox (14) comprises a gearing system (16) that is configured to operatively transmit a rotational output (18) of an electric motor (20) to a tool (22). The gearbox (14) comprises a motor mount (24) that is configured to be operatively coupled to the electric motor (20). The plurality of input gears (26) have different configurations, and each input gear (26) is configured to be operatively installed in the gearbox (14) for operatively meshing with an output gear (28) mounted on an output shaft (30) of the electric motor (20).

### RELATED APPLICATION

This application claims priority to U.S. Provisional Patent Application No. 63/606,926, filed on Dec. 6, 2023, the complete disclosure of which is incorporated herein by reference.

### FIELD

This disclosure relates to portable machine tools.

### INTRODUCTION

As the operation of portable machine tools, such as portable boring machines, requires precise speed control of the machine tool, e.g., dependent on the cutting tool's position on a boring bar or specific application, a multi-speed gearbox is necessary to effectively control the machine tool. Furthermore, a multi-speed gearbox may be utilized to expand the operational range of the machine tool by synchronizing the motor's speed with a required bar speed for a given application. Given the large variety of electric motors, each having their own operating speeds, power sources (e.g., AC or DC), and form factors, a gearbox configured to be operational with a diverse range of motors is advantageous.

### BRIEF DESCRIPTION OF THE DRAWINGS

FIG. 1 is a schematic diagram representing portable machine tool kits according to the present disclosure.

FIG. 2 is an isometric view of portions of a portable machine tool according to the present disclosure.

FIG. 3 is another isometric view of portions of the portable machine tool of FIG. 2.

FIG. 4 is another isometric view of portions of the portable machine tool of FIG. 2.

FIG. 5 is another isometric view of portions of the portable machine tool of FIG. 2.

FIG. 6 is an isometric view of the motor mount of the portable machine tool of FIG. 2.

FIG. 7 is another isometric view of portions of the portable machine tool of FIG. 2.

FIG. 8 is another isometric view of portions of the portable machine tool of FIG. 2.

FIG. 9 is an isometric view of portions of the portable machine tool of FIG. 2.

FIG. 10 is a flowchart schematically representing methods according to the present disclosure.

### DETAILED DESCRIPTION

Various aspects and examples of portable machine tool kits (i.e., component parts to be assembled to form portable machine tools), portable machine tools, and gearboxes thereof for use with a variety of electric motors are described below and illustrated in the associated drawings. Unless otherwise specified, portable machine tool kits and portable machine tools in accordance with the present teachings and/or their various components may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature, and not all examples and embodiments provide the same advantages or the same degree of advantages.

In general, gearboxes for use with portable machine tools according to the present disclosure are configured to interface with electric motors to transfer the rotational output of the rotor of an electric motor to a rotating tool of the portable machine tool, such as a boring bar. In some examples, the gearbox is a reduction gearbox (i.e., speed reducer or gear reducer), in which the rotational speed of the output of the gearbox is slower than the rotational output of the motor, thereby increasing the torque of the output of the gearbox.

The gearboxes include adaptive motor mounts configured to support one or more portions of an electric motor. The motor mount may be configured to support and engage a wide variety of different electric motors, e.g., by having suitable mounting surfaces, fastener anchor points, and/or other suitable structures for supporting an electric motor. In some examples, the motor mount may include one or more structures suitable for supporting supplementary components of the electric motor, such as cooling components, controls, etc. Accordingly, the adaptive motor mount enables the gearbox to be driven by any suitable electrical motor.

Due to the different output speeds and torque curves produced by different electric motors, the gearbox includes an interchangeable input gear configured to positively engage an output gear of the electric motor. For example, if the electric motor is replaced with a different electric motor having a different configuration, the input gear may be replaced with one that produces the same, or substantially similar, operating speed range on the output of the gearbox. In other words, the input gear may be selectively chosen based on the selected electric motor to ensure a desired speed and/or torque range is applied to the portable machine tool.

The input gear is coupled to a gearing system (i.e., gear cluster). The gearing system includes a plurality of individual gears, each coupled to one another either via respective engagement surfaces (e.g., teeth) that are arranged around a periphery of the gears or a respective coupling shaft. In some examples, translation of one or more of the gears along the respective shaft is utilized to shift the gearbox between gear ratios. For example, a coupling shaft may have two or more gears disposed thereon, each gear having a different number of teeth, and a user of the gearbox may translate one or both of the gears along the shaft to selectively engage with another gear of the gear cluster.

In principle, gearboxes according to the present disclosure may be operable with any gear ratio achievable by the installed gears. In some examples, such as the case in which two or more different combinations of gears may produce identical or nearly identical gear ratios, only one of the combinations may be accessible to a user for selection.

In some examples, operation of the portable machine tool may require the gearbox to be operated in reverse. Accordingly, the gear cluster may include a reverse gearing portion (i.e., reverse gear) and a corresponding internal mechanical change of the drive train (e.g., to engage the reverse gear). In some examples, the mechanical change of the drive train may occur via a translation of one or more portions of the reverse gearing portion along a shaft to selectively engage the reverse gear. In some examples, the reverse gear may be engaged by a user via a reverse gear shift coupled to a user interface component, such as a knob, switch, slider, shift lever, etc., wherein the gear shift is configured to selectively engage the reverse gear.

In some examples, the gearbox may include a speed control system. The speed control system may include a speed monitor located on the gearbox, the speed monitor being configured to communicate to an electronic controller of the electric motor. For example, the speed monitor may monitor the rotational speed of one or more components of the gearbox, such as one or more portions of the gear cluster, and send corresponding command signals to the controller of the electric motor to update the operating speed of the electric motor to achieve a desired output speed.

In some examples, the speed monitor may comprise a monitored gear located within the gear cluster. The monitored gear may include one or more structures suitable to be detected by a sensor, such that a speed of the monitored gear can be determined. In some examples, the structures may comprise a plurality of castellations or protrusions extending from a surface of the monitored gear, wherein the castellations/protrusions are configured to be detectable by the sensor (e.g., an electromagnetic sensor, a light sensor, etc.) as the monitored gear rotates. For example, the rate at which the castellations/protrusions are detected by the sensor may be used to determine the revolutions per minute (RPM) of the monitored gear, which may be used to determine the output speed of the gearbox. Additionally or alternatively, the structures may comprise one or more magnets configured to be detectable by a magnetic sensor.

The output of the speed sensor is used to produce a control signal for the controller of the electric motor. For example, if the speed monitor detects that the operating speed of the gearbox is too slow for a given application, a signal may be sent to the electronic controller of the motor to increase the speed of the motor. Conversely, if the speed monitor detects that the operating speed of the gearbox is too fast, a signal may be sent to the electronic controller of the motor to decrease the speed of the motor. In this manner, the speed of the motor may be controlled in real-time to ensure the rotating output of the gearbox is sufficient for the given application. Accordingly, as the speed monitor is located on gearbox, interchanging the motors does not affect the speed monitor of the gearbox.

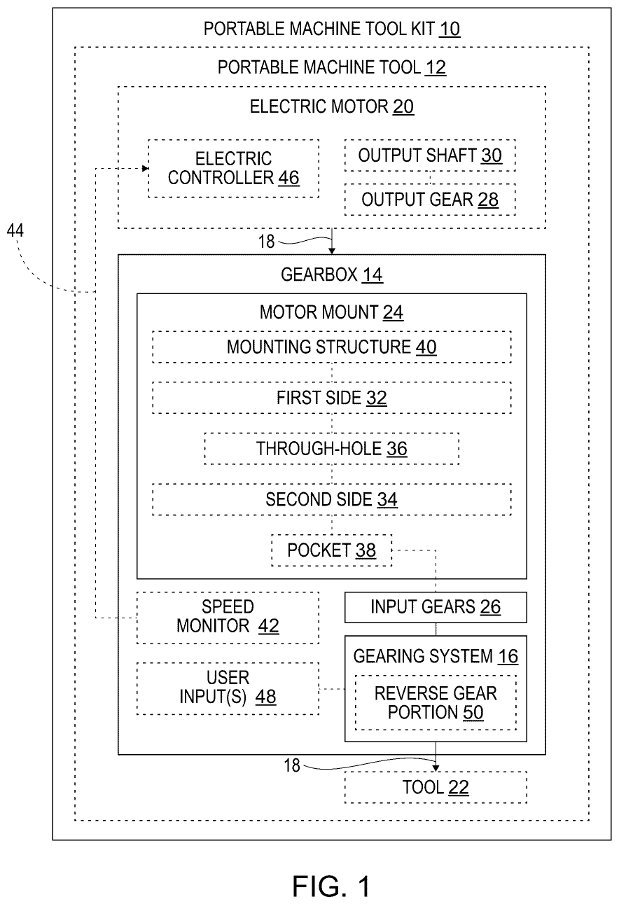

The following describes selected aspects of illustrative gearboxes as well as related systems and/or methods. Generally, in FIG. 1, elements that are likely to be included in a given example are illustrated in solid lines, while elements that are optional to a given example or that correspond to one or more specific examples are illustrated in broken lines. The examples are intended for illustration and should not be interpreted as limiting the scope of the present disclosure.

As shown schematically in FIG. 1, portable machine tool kits 10 for assembling a portable machine tool 12 typically comprise at least a gearbox 14 and a plurality of input gears 26. The gearbox 14 comprises a gearing system 16 that is configured to operatively transmit a rotational output 18 of an electric motor 20 to a tool 22, such as a boring bar with a cutting tool. The gearbox 14 comprises a motor mount 24 that is configured to be operatively coupled to the electric motor 20. The plurality of input gears 26 have different configurations (e.g., different number of teeth). Each input gear 26 is configured to be operatively installed in the gearbox 14 for operatively meshing with an output gear 28 mounted on an output shaft 30 of the electric motor 20.

The gearbox 14 may be a reduction gearbox, having gearing configured to produce a rotational speed that is slower than the rotational output of the motor, thereby increasing the torque. Conversely, the gearbox 14 may be a multiplier, having gearing configured to produce a rotational speed that is faster than the rotational output of the motor.

In some examples as schematically represented in FIG. 1, the motor mount 24 comprises a first side 32 that is configured to be operatively coupled to the electric motor 20, and a second side 34 that is opposite the first side 32. The motor mount 24 defines a through-hole 36 that extends from the first side 32 to the second side 34, and the through-hole 36 is configured to receive the output shaft 30 of the electric motor 20. The gearbox 14 is configured to operatively receive a selected input gear 26 of the plurality of input gears 26 for operative meshing with the output gear 28 of the electric motor.

In some examples, the motor mount 24 defines a pocket 38 on the second side 34 of the motor mount adjacent to the through-hole 36. The pocket 38 is configured to operatively receive the selected input gear 26 for operative meshing with the output gear 28 of the electric motor.

In some examples, the motor mount 24 comprises mounting structure 40 on the first side 32 of the motor mount 24. The mounting structure 40 is configured to be operatively coupled to individual motors of a plurality of different electric motors 20. That is, the mounting structure 40 may comprise various mounting surfaces, fastener anchor points, and/or other suitable structures for supporting different electric motors. Additionally or alternatively, a plurality of different mounting structures 40 may be provided in a portable machine tool kit 10 and be interchangeable on the motor mount 24. Accordingly, a mounting structure 40 may be selected for operative use with a specific electric motor 20.

Due to potentially different output speeds and/or torque curves produced by different electric motors 20, a plurality of interchangeable input gears 26 enables the use of different electric motors. For example, if one electric motor is replaced with a different electric motor having a different rotational output speed, input gear 26 may be replaced with a different input gear 26 that produces the same, or substantially similar, operating speed range on the rotating output of the gearbox. Additionally or alternatively, if a user of a portable machine tool kit 10 typically uses a particular configuration of electric motor, a single portable machine tool kit 10 may be provided regardless of the user's particular configuration of electric motor. Accordingly, a provider of portable machine tool kits 10 need not have specific configurations (e.g., specific SKUs) for every possible electric motor that a user may utilize. As a result, the user may select an input gear 26 from the plurality of input gears 26 in the portable machine tool kit 10 based on the particular electric motor 20 to be used, to ensure a desired speed and/or torque range is applied to the tool 22.

The gearing system 16 of the gearbox 14 of a portable machine tool kit 10 typically comprises a plurality of individual gears, each of which is coupled to one another, either via respective engagement surfaces (e.g., teeth) arranged around a periphery of the gears or a respective coupling shaft. In some examples, translation of one or more of gears along the respective shaft is utilized to shift the gearbox between gear ratios. For example, a coupling shaft may have two or more gears disposed thereon, each gear having a different number of teeth. A user of gearbox 14 thus may translate one or both of the gears along the coupling shaft to selectively engage with another gear of the gearing system 16.

As some applications may require gearbox 14 to be operated in reverse, gearing system 16 may comprise a reverse gear portion 50 that is configured to selectively reverse a rotational direction of the rotational output 18. The reverse gear portion 50, or a reverse gear thereof, may be selectively engaged by a corresponding internal mechanical change of the gearbox's drive train (e.g., to engage the reverse gear). For example, engagement of the reverse gear may be initiated by a user of the portable machine tool 12 assembled from a portable machine tool kit 10.

With continued reference to FIG. 1, in some examples, the gearbox 14 comprises a speed monitor 42 that is configured to monitor an output rotational speed of the gearbox 14 and send a control signal 44 to an electronic controller 46 of the electric motor 20. The control signal 44 is based at least in part on the output rotational speed and a desired rotational speed of the gearbox 14, such as set by a user. That is, the gearbox 14 may further comprise a user input 48 that is configured for selection of the desired rotational speed of the gearbox 14.

As an example, if the speed monitor 42 detects that the output rotational speed (or operating speed) of the gearbox 14 is too slow for a given application, the control signal 44 may be configured to increase the power supplied to the electric motor 20, thereby increasing the operating speed of the gearbox 14. Conversely, if the speed monitor 42 detects that the operating speed of the gearbox 14 is too fast, the control signal 44 may be configured to decrease the power supplied to the electric motor 20, thereby decreasing the operating speed of the gearbox 14. Accordingly, the operating speed of the electric motor 20 may be controlled in real-time to ensure that the operating speed of the gearbox 14 is appropriately set for the respective application. Furthermore, as the speed monitor 42 is a component of the gearbox 14, interchanging the electric motors 20 does not affect the control signal 44 from the gearbox 14.

The electronic controller 46 of an electric motor 20 may be any suitable device or devices that are configured to perform the functions of the electronic controller discussed herein. For example, the electronic controller 46 may include one or more of a dedicated controller, a special-purpose controller, a personal computer, a special-purpose computer, a display device, a logic device, a memory device, and/or a memory device having computer-readable media suitable for storing computer-executable instructions for implementing aspects of electric motors 20 and/or methods according to the present disclosure.

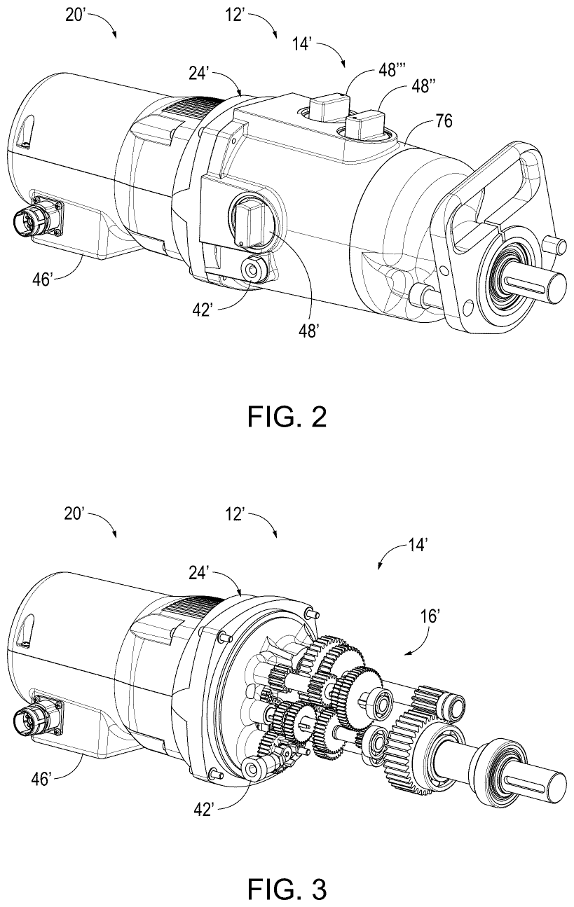

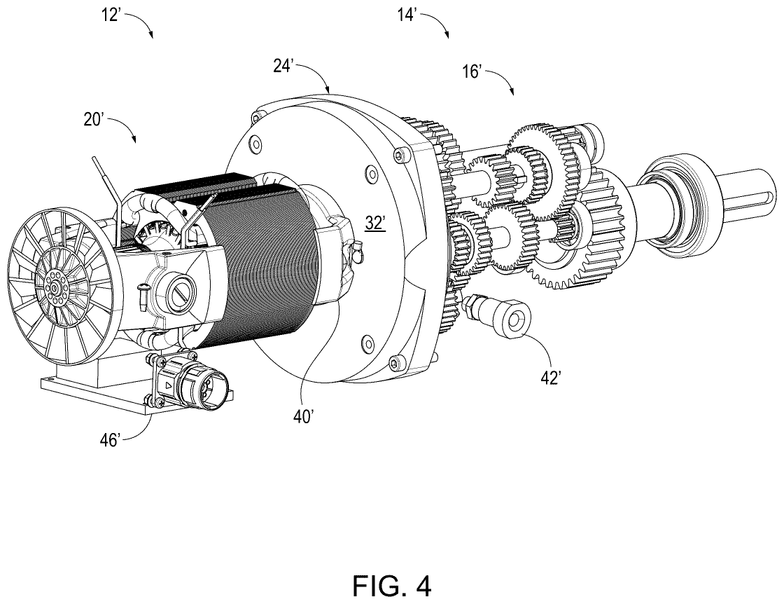

Turning now to FIGS. 2-9, an illustrative non-exclusive example of portions of a portable machine tool 12 assembled from a portable machine tool kit 10 are illustrated. Where appropriate, the reference numerals from the schematic illustration of FIG. 1 are used with one more prime symbols (′) to designate corresponding parts of the example of FIGS. 2-9. However, portable machine tool kits 10, portable machine tools 12, and their component parts are not limited to the specific embodiments of FIGS. 2-9 and may incorporate any number of the various aspects, configurations, characteristics, properties, etc. of portable machine tool kits that are illustrated in and discussed with reference to the schematic representation of FIG. 1 and/or the embodiments of FIGS. 2-9, as well as variations thereof, without requiring the inclusion of all such aspects, configurations, characteristics, properties, etc. For the purpose of brevity, each previously discussed component, part, portion, aspect, region, etc., or variants thereof may not be discussed, illustrated, and/or labeled again with respect to FIGS. 2-9; however, it is within the scope of the present disclosure that the previously discussed features, variants, etc. may be utilized with the example of FIGS. 2-9.

With reference initially to FIG. 2, example portable machine tool 12′ comprises an electric motor 20′ operatively coupled to a motor mount 24′ of a gearbox 14′. The gearbox 14′ comprises a housing 76, a user control 48′ configured to select a direction of rotational output of the gearbox 14′, and additional user controls 48″ and 48″′ for selection of a desired gear ratio (and thus rotational speed) of the gearbox 14′.

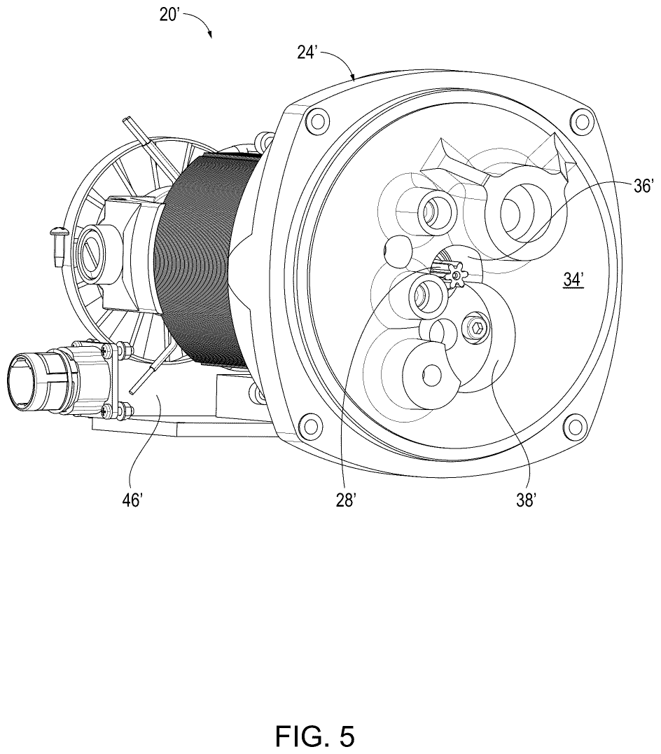

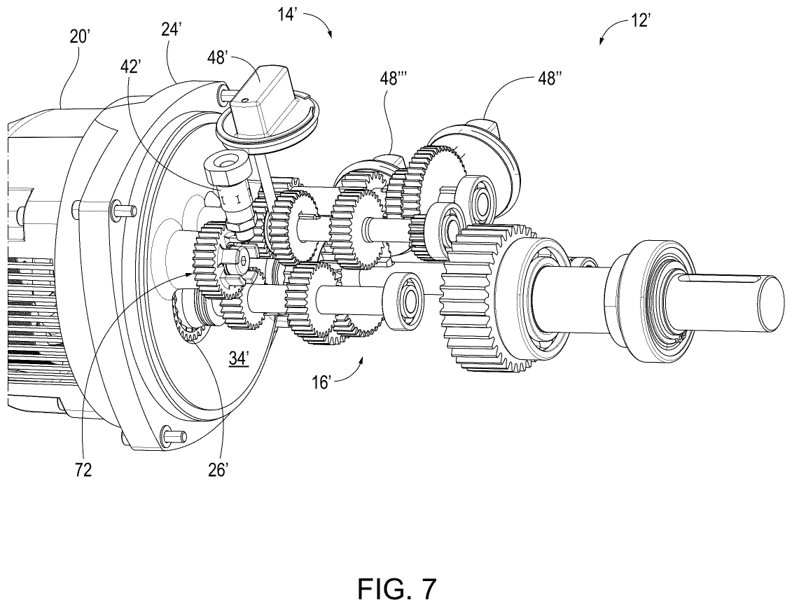

As seen in FIG. 5, example motor mount 24′ is an example of a motor mount 24 that defines a through-hole 36, through which an output gear 28′ on an output shaft (not seen) of the electric motor 20′ extends. The second side 34′ of the motor mount 24′ defines a pocket 38′ that is configured to receive a selected input gear 26′ (seen in FIG. 7) for operative meshing with the output gear 28′.

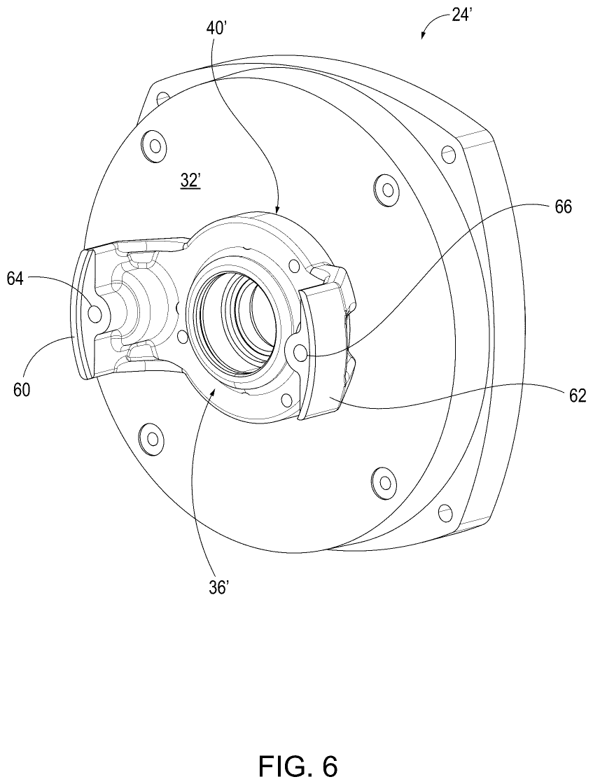

As seen in FIG. 6, example motor mount 24′ comprises mounting structure 40′ on the first side 32′ of the motor mount 24′. The example mounting structure 40′ comprises opposing arms 60, 62 that extend away from the first side 32′ of the motor mount 24′. Each arm is configured to couple to corresponding portions of an electric motor 20 and comprises a respective mounting hole 64, 66 configured to receive corresponding fasteners for fastening the electric motor 20 thereon.

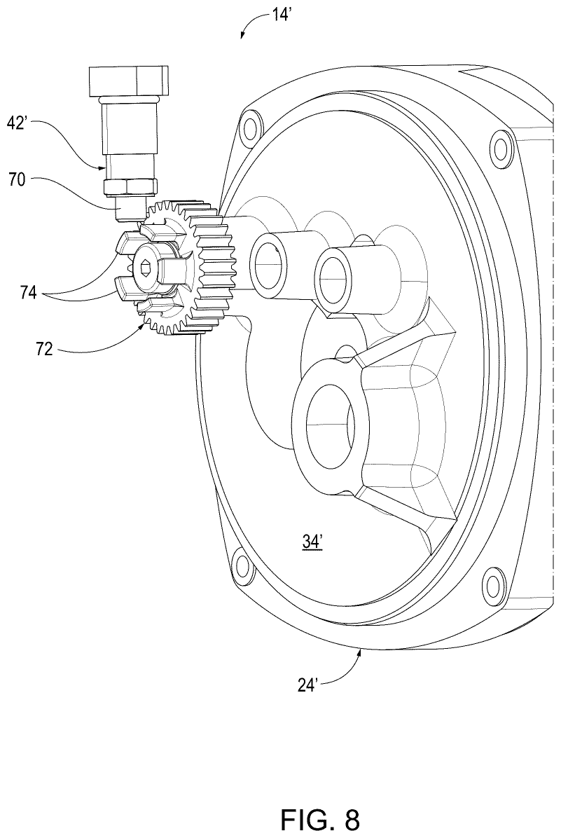

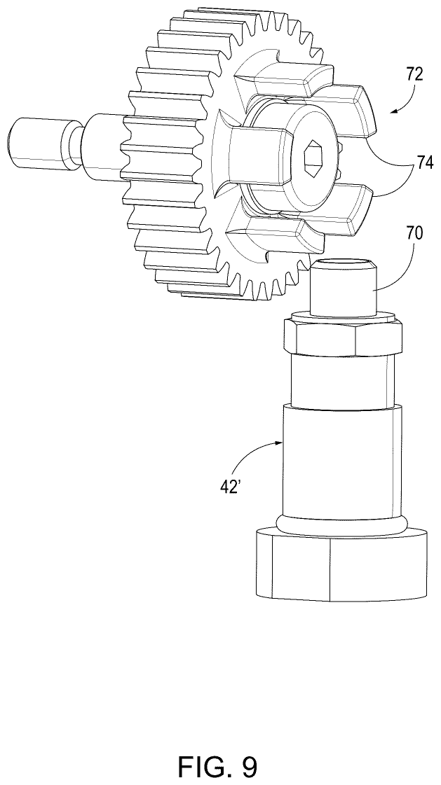

Turning now to FIGS. 7-9, gearbox 14′ is an example of a gearbox 14 that comprises a speed monitor 42′. The speed monitor 42′ comprises a sensor 70, and the gearing system 16′ of gearbox 14′ comprises a monitored gear 72 sensed by the sensor 70. As shown in FIGS. 8 and 9, monitored gear 72 comprises a plurality of castellations (or protrusions) 74 suitable to be detected by the sensor 70 of the speed monitor 42′, such that a rotational speed of the monitored gear 72 can be determined. For example, a detected rate at which castellations/protrusions 74 are detected by the sensor 70 may be used to determine the revolutions per minute (RPM) of the monitored gear 72.

Sensor 70 may comprise an infrared (IR) sensor, a capacitive sensor, a light sensor, and/or other suitable sensor(s) configured to detect the motion of the castellations/protrusions 74. Additionally, or alternatively, a monitored gear may comprise one or more magnets configured to be detectable by a magnetic sensor 70.

The detected speed of speed sensor 70 is used by the speed monitor 72′ to produce a control signal 44 for the electronic controller 46 of the electric motor 20′, as discussed herein.

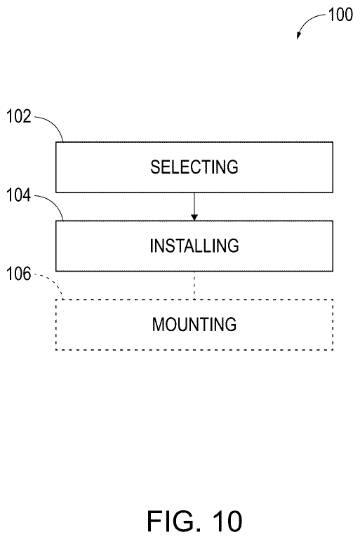

FIG. 10 schematically provides a flowchart that represents illustrative, non-exclusive examples of methods 100 according to the present disclosure. In FIG. 10, some steps are illustrated in dashed boxes, indicating that such steps may be optional or may correspond to an optional version of a method according to the present disclosure. That said, not all methods according to the present disclosure are required to include the steps illustrated in solid boxes. The methods and steps illustrated in FIG. 10 are not limiting and other methods and steps are within the scope of the present disclosure, including methods having greater than or fewer than the number of steps illustrated, as understood from the discussions herein.

As schematically represented in FIG. 10, methods 100 of assembling a portable machine tool 12 from a portable machine tool kit 10 according to the present disclosure comprise at least selecting 102 a selected input gear 26 from a plurality of input gears 26 based on a configuration of an electric motor 20 of the portable machine tool 12, and installing 104 the selected input gear 26 in a gearbox 14 of the portable machine tool 12. Some methods 100 further comprise mounting 106 the electric motor 20 to a motor mount 24 of the portable machine tool 12.

Illustrative, non-exclusive examples of inventive subject matter according to the present disclosure are described in the following enumerated paragraphs:

A. A portable machine tool kit (10) for assembling a portable machine tool (12), the portable machine tool kit (10) comprising:
a gearbox (14) comprising a gearing system (16) configured to operatively transmit a rotational output (18) of an electric motor (20) to a tool (22), wherein the gearbox (14) comprises a motor mount (24) configured to be operatively coupled to the electric motor (20); and
a plurality of input gears (26) having different configurations, wherein each input gear (26) of the plurality of input gears (26) is configured to be operatively installed in the gearbox (14) for operatively meshing with an output gear (28) mounted on an output shaft (30) of the electric motor (20).

A1. The portable machine tool kit (10) of paragraph A,
wherein the motor mount (24) comprises:
   a first side (32) configured to be operatively coupled to the electric motor (20); and
   a second side (34) opposite the first side (32);
wherein the motor mount (24) defines a through-hole (36) extending from the first side (32) to the second side (34), wherein the through-hole (36) is configured to receive the output shaft (30) of the electric motor (20); and
wherein the gearbox (14) is configured to operatively receive a selected input gear (26) of the plurality of input gears (26) for operative meshing with the output gear (28).

A1.1. The portable machine tool kit (10) of paragraph A1, wherein the motor mount (24) defines a pocket (38) on the second side (34) adjacent to the through-hole (36), and wherein the pocket (38) is configured to operatively receive the selected input gear (26) of the plurality of input gears (26) for operative meshing with the output gear (28).

A1.2. The portable machine tool kit (10) of any of paragraphs A1-A1.1, wherein the motor mount (24) comprises mounting structure (40) on the first side (32) of the motor mount (24), wherein the mounting structure (40) is configured to be operatively coupled to individual ones of a plurality of different electric motors (20).

A2. The portable machine tool kit (10) of any of paragraphs A-A1.2, wherein the gearbox (14) comprises a speed monitor (42) configured to monitor an output rotational speed of the gearbox (14) and send a control signal (44) to an electronic controller (46) of the electric motor (20) based at least in part on the output rotational speed and a desired rotational speed of the gearbox (14).

A2.1. The portable machine tool kit (10) of paragraph A2, wherein the gearbox (14) further comprises a user input (48) configured for selection of the desired rotational speed of the gearbox (14).

A3. The portable machine tool kit (10) of any of paragraphs A-A2.1, wherein the gearing system (16) comprises a reverse gear portion (50) configured to selectively reverse a rotational direction of the rotational output (18).

A4. The portable machine tool kit (10) of any of paragraphs A-A3, wherein the tool (22) is a boring bar.

A5. The portable machine tool kit (10) of any of paragraphs A-A4, further comprising the tool (22).

B. A method (100) of assembling a portable machine tool (12) from the portable machine tool kit (10) of any of paragraphs A-A5, the method (100) comprising: selecting (102) a/the selected input gear (26) from the plurality of input gears (26) based on a configuration of the electric motor (20); and installing (104) the selected input gear (26) in the gearbox (14).

B1. The method (100) of paragraph B, further comprising mounting (106) the electric motor (20) to the motor mount (24).

The different embodiments and examples described herein provide several advantages over known solutions for utilizing an electric motor to drive a portable machine tool. For example, illustrative embodiments and examples described herein allow for the use of various different electric motors, regardless of form factor, operating speed, or power source.

Additionally and among other benefits, illustrative embodiments and examples described herein allow for monitoring of the output speed of the gearbox to control the operating speed of the electric motor.

Additionally and among other benefits, illustrative embodiments and examples described herein allow for speed monitoring of the gearbox to be independent of the electric motor.

No known system or device can perform these functions. However, not all embodiments and examples described herein provide the same advantages or the same degree of advantage.

The disclosure set forth above may encompass multiple distinct examples with independent utility. Although each of these examples has been disclosed in its preferred form(s), the specific embodiments thereof as disclosed and illustrated herein are not to be considered in a limiting sense, because numerous variations are possible. The subject matter of the example(s) includes all novel and nonobvious combinations and subcombinations of the various elements, features, functions, and/or properties disclosed herein.

Certain combinations and subcombinations regarded as novel and nonobvious are particularly pointed out throughout this disclosure. Other combinations and subcombinations of features, functions, elements, and/or properties may be claimed, with or without variation in scope, in applications claiming priority from this or a related application.

Explicit reference is hereby made to all examples, embodiments, inventions, labels, terms, descriptions, and illustrative measurements shown in the drawings and/or in any included appendices, whether or not described further herein. To the extent that section headings are used within this disclosure, such headings are for organizational purposes only.

1. A portable machine tool kit (10) for assembling a portable machine tool (12), the portable machine tool kit (10) comprising:
a gearbox (14) comprising a gearing system (16) configured to operatively transmit a rotational output (18) of an electric motor (20) to a tool (22), wherein the gearbox (14) comprises a motor mount (24) configured to be operatively coupled to the electric motor (20); and
a plurality of input gears (26) having different configurations, wherein each input gear (26) of the plurality of input gears (26) is configured to be operatively installed in the gearbox (14) for operatively meshing with an output gear (28) mounted on an output shaft (30) of the electric motor (20).

2. The portable machine tool kit (10) of claim 1,
wherein the motor mount (24) comprises:
a first side (32) configured to be operatively coupled to the electric motor (20); and
a second side (34) opposite the first side (32);
wherein the motor mount (24) defines a through-hole (36) extending from the first side (32) to the second side (34), wherein the through-hole (36) is configured to receive the output shaft (30) of the electric motor (20); and
wherein the gearbox (14) is configured to operatively receive a selected input gear (26) of the plurality of input gears (26) for operative meshing with the output gear (28).

3. The portable machine tool kit (10) of claim 2, wherein the motor mount (24) defines a pocket (38) on the second side (34) adjacent to the through-hole (36), and wherein the pocket (38) is configured to operatively receive the selected input gear (26) of the plurality of input gears (26) for operative meshing with the output gear (28).

4. The portable machine tool kit (10) of claim 2, wherein the motor mount (24) comprises mounting structure (40) on the first side (32) of the motor mount (24), wherein the mounting structure (40) is configured to be operatively coupled to individual ones of a plurality of different electric motors (20).

5. The portable machine tool kit (10) of claim 1, wherein the gearbox (14) comprises a speed monitor (42) configured to monitor an output rotational speed of the gearbox (14) and send a control signal (44) to an electronic controller (46) of the electric motor (20) based at least in part on the output rotational speed and a desired rotational speed of the gearbox (14).

6. The portable machine tool kit (10) of claim 5, wherein the gearbox (14) further comprises a user input (48) configured for selection of the desired rotational speed of the gearbox (14).

7. The portable machine tool kit (10) of claim 1, wherein the gearing system (16) comprises a reverse gear portion (50) configured to selectively reverse a rotational direction of the rotational output (18).

8. The portable machine tool kit (10) of claim 1, wherein the tool (22) is a boring bar.

9. The portable machine tool kit (10) of claim 1, further comprising the tool (22).

10. The portable machine tool kit (10) of claim 9, wherein the tool (22) is a boring bar.

11. A method (100) of assembling a portable machine tool (12) from the portable machine tool kit (10) of claim 1, the method (100) comprising:
selecting (102) a selected input gear (26) from the plurality of input gears (26) based on a configuration of the electric motor (20); and
installing (104) the selected input gear (26) in the gearbox (14).

12. The method (100) of claim 11, further comprising mounting (106) the electric motor (20) to the motor mount (24).
